(19) United States
(12) Patent Application Publication
(10) Pub. No.: US 2023/0143452 A1
(43) Pub. Date: May 11, 2023

(54) METHOD AND APPARATUS FOR GENERATING IMAGE, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Zhiliang XU, Beijing (CN); Zhibin HONG, Beijing (CN)

(21) Appl. No.: 17/982,832

(22) Filed: Nov. 8, 2022

(30) Foreign Application Priority Data
Nov. 9, 2021 (CN) 20211320636.0

(51) Int. Cl. G06T 7/55; G06V 10/40; G06V 10/24

(52) U.S. Cl. CPC G06T 7/55; G06V 10/40; G06V 10/24; G06T 2207/20221; G06T 2207/20084

(57) ABSTRACT

A method for generating an image includes: obtaining a reference image and an image to be processed; extracting target fusion features from the reference image; determining a plurality of depth feature maps corresponding to the reference image based on the target fusion features; obtaining a target feature map by fusing the plurality of depth feature maps based on the target fusion features; and generating a target image by processing the image to be processed based on the target feature map.

### CROSS REFERENCE TO RELATED APPLICATIONS

This application claims priority and benefits to Chinese Application No. 202111320636.0, filed on Nov. 9, 2021, the entire content of which is incorporated herein by reference.

### TECHNICAL FIELD

The disclosure relates to a field of Artificial Intelligence (AI) technologies, especially fields of deep learning and computer vision technologies, and can be applied to scenarios such as face image processing and face image recognition, in particular to a method for generating an image, an apparatus for generating an image, an electronic device and a storage medium.

### BACKGROUND

Artificial Intelligence (AI) is a subject that causes computers to simulate certain thinking processes and intelligent behaviors (such as learning, reasoning, thinking and planning) of human beings, which covers both hardware-level technologies and software-level technologies. The AI hardware-level technologies generally include technologies such as sensors, special AI chips, cloud computing, distributed storage, and big data processing. The AI software-level technologies generally include several major aspects such as computer vision technology, speech recognition technology, natural language processing technology, machine learning/deep learning, big data processing technology and knowledge graph technology.

### SUMMARY

According to a first aspect, a method for generating an image is provided. The method includes: obtaining a reference image and an image to be processed; extracting target fusion features from the reference image; determining a plurality of depth feature maps corresponding to the reference image based on the target fusion features; obtaining a target feature map by fusing the plurality of depth feature maps based on the target fusion features; and generating a target image by processing the image to be processed based on the target feature map.

According to a second aspect, an electronic device is provided. The electronic device includes: at least one processor and a memory communicatively coupled to the at least one processor. The memory stores instructions executable by the at least one processor, and when the instructions are executed by the at least one processor, the at least one processor is caused to implement the method for generating an image according to the first aspect of the disclosure.

According to a third aspect, a non-transitory computer-readable storage medium storing computer instructions is provided. The computer instructions are configured to cause a computer to implement the method for generating an image according to the first aspect of the disclosure.

It is understandable that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart illustrating a method for generating an image according to examples of the disclosure.

FIG. 2 is a schematic diagram illustrated a U-shaped neural network (also called Unet) according to examples of the disclosure.

FIG. 3 is a flowchart illustrating a method for generating an image according to examples of the disclosure.

FIG. 4 is a block diagram illustrating an apparatus for generating an image according to examples of the disclosure.

FIG. 5 is a block diagram illustrating an apparatus for generating an image according to examples of the disclosure.

FIG. 6 is a schematic diagram illustrating an example electronic device for performing the method for generating an image according to examples of the disclosure.

### DETAILED DESCRIPTION

The following describes embodiments of the disclosure with reference to the accompanying drawings, which includes various details of the embodiments of the disclosure to facilitate understanding, which shall be considered merely examples. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

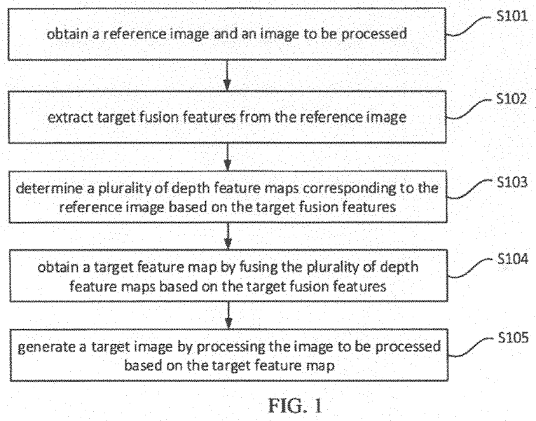

FIG. 1 is a flowchart illustrating a method for generating a method according to examples of the disclosure.

It is noteworthy that the method for generating an image of the embodiment is performed by an apparatus for generating an image. The apparatus can be realized by software and/or hardware. The apparatus can be included in an electronic device. The electronic device can be one selected from a group including, but not limited to, a terminal and a server.

Embodiments of the disclosure relate to the field of AI technologies, in particular to the fields of computer vision and deep learning technologies, and can be applied to scenarios such as face image processing and face image recognition.

AI is a new technical science that studies and develops theories, methods, technologies and applied systems for simulating, extending and expanding human intelligence.

Deep Learning (DL) is to learn internal laws and representation levels of sample data. The information obtained in the learning process is of great help to interpretation of data such as text, images and sounds. The ultimate goal of DL is to enable machines to have an ability to analyze and learn like humans, having an ability to recognize data such as text, images and sounds.

Computer vision refers to the use of machine vision such as cameras and computers instead of human eyes to identify, track and measure targets, and further perform graphics processing, to make the images processed by the computers more suitable for human eyes to observe or for being transmitted to instruments for detection.

Face image processing refers to using computer technology to process inputted face images or video streams, to extract face image information contained in the images. Face image recognition refers to extracting location information of each major facial organ in the face image based on facial features of the face image, and further extracting features embedded in each face based on the location information.

When the method for generating an image according to the disclosure is applied to scenarios such as face image processing and face image recognition, the amount of computation required for the image fusion can be effectively reduced. In this way, the method can be applied to electronic devices with poor computing capability. Therefore, the image generation effect can be effectively improved while saving the computing resources.

It is noteworthy that the collection, storage, use, processing, transmission, provision and disclosure of the personal information of users involved in embodiments of the disclosure are handled in a process that complies with relevant laws and regulations and is not contrary to public order and morality.

As illustrated in FIG. 1, the method for generating an image includes the following blocks.

At block S101, a reference image and an image to be processed are obtained.

An image that is to be processed currently is referred to as the image to be processed, and there may be one or more images to be processed. The images to be processed may be captured by an image capturing device having a photographing function such as a mobile phone or a camera, or the image to be processed may also be obtained from a video stream. For example, some video image frames can be extracted from multiple video frames included in a video as the images to be processed, which is not limited in the disclosure.

In the execution process of the method for generating an image, the image that plays a reference role for the image to be processed can be called reference image, and there may be one or more reference images. ‘The reference images may have respective identity information. The reference image may be, for example the same image as the image to be processed, or the image sharing associated information with the image to be processed, which is not limited in the disclosure.

The identity information may be, for example, clothing information, hairstyle information, body shape information of a person contained in the reference image, or any other information that can represent the identity of the person contained in the reference image, which is not limited in the disclosure.

That is, an application scenario of the embodiments of the disclosure may be, for example, obtaining a reference image containing the identity information, extracting the identity information from the reference image, and fusing the identity information with the image to be processed, to generate the target image containing the identity information of the person contained in the reference image, which is not limited in the disclosure.

It is noteworthy that the “reference image” and the “image to be processed” mentioned in the disclosure are not for a specific user, and cannot reflect the personal information of a specific user. Moreover, the reference image, the image to be processed and the above-mentioned identity information are obtained after the authorization of relevant users, and the acquisition process conforms to the relevant laws and regulations, and does not violate public order and good customs.

In some examples, obtaining the reference image and the image to be processed may include obtaining a source image and an initial image, performing point alignment processing on a source area image contained in the source image and a standard object image based on a first number of key points, to obtain the reference image; and performing alignment processing on an initial area image contained in the initial image and the standard object image based on a second number of key points, to obtain the image to be processed. Since the reference image and the image to be processed are obtained by using different alignment methods separately, the alignment effect of the reference image and the alignment effect of the image to be processed can be effectively improved in the subsequent execution of the method for generating an image, to ensure that a complete area image can be determined based on the reference image and the image to be processed, which facilitates the subsequent image fusion of the reference image and the image to be processed, and ensures that the correct image information can be read from the reference image and the image to be processed, thereby effectively improving the image generation effect.

The unprocessed reference image obtained in the initial stage can be called the source image, and correspondingly, the unprocessed image to be processed obtained in the initial stage of the method can be called the initial image. That is, the source image and the initial image may be acquired, and then the alignment processing is performed on the source image and the initial image respectively to obtain the reference image and the image to be processed, which is not limited in the disclosure.

Images may be obtained by photographing a corresponding object, which may be, for example, a person, an animal, a plant, or a part of the aforementioned objects (e.g., facial organs, hair, face outline). For example, the object in the disclosure can be a person, the image capturing and identity information extraction of the person are performed with the authorization of the relevant user, and the acquisition process is in accordance with the relevant laws and regulations and does not violate public order and morals.

There may be a plurality of objects included in an image, and the plurality of objects may correspond to respective area images (for example, each area image is a part of the image). In examples of the disclosure, an object depicted in the source image may be used as a first object, and the image area corresponding to the first object may be used as the source area image. Correspondingly, an object depicted in the initial image may be used as a second object, and the image area corresponding to the second object may be used as the initial area image, which is not limited in the disclosure.

For example, when the image is a face image, the object can be one selected from a group consisted of facial organs, hair and face contour, and the area corresponding to the object can be an facial organ area, a hair area or a face contour area, which is not limited in the disclosure.

Processing the source image and the initial image respectively to obtain the reference image and the image to be processed may include: selecting key points (the number of the key points equals to the first number) from the source area image contained in the source image, selecting key points (the number of the key points equals to the second number) from the initial area image contained in the initial image, performing point alignment processing on the source image and the standard object image based on the first number of key points to obtain the reference image, and performing the alignment processing on the initial area image contained in the initial image and the standard object image based on the second number of key points, to obtain the image to be processed.

An image used as a reference for aligning the source area image or the initial area image is called the standard object image. The standard object image may be obtained through annotation in advance, which is not limited in the disclosure.

For example, the standard object image may be a high-definition face image in a Flickr Faces High Quality (FFHQ) which includes about 70,000 high-definition face images in a Portable Network Graphics (PNG) format with a resolution of 1024×1024, which is not limited in the disclosure.

For example, performing the point alignment processing on the source area image contained in the source image and the standard object image based on the first number of key points includes using the Additive Angular Margin Loss for Deep Face Recognition (ArcFace) algorithm to perform the point alignment processing on the source area image and the standard object image based on 5 key points to obtain the reference image, which is not limited in the disclosure.

For example, performing the alignment processing on the initial area image contained in the initial image and the standard object image based on the second number of key points includes performing the point alignment processing on the initial area image and the standard object image based on 72 key points with the same alignment method as that used by the FFHQ, to obtain the image to be processed, which is not limited in the disclosure.

It is noteworthy that the “reference image” and the “image to be processed” mentioned in the disclosure are not are not for a specific user, and cannot reflect the personal information of a specific user. Moreover, the reference image and the image to be processed are obtained after the authorization of relevant users, and the acquisition process conforms to the relevant laws and regulations, and does not violate public order and good customs.

At block S102, target fusion features are extracted from the reference image.

Features used to describe the identity information of the reference image can be called the target fusion features, that is, the target fusion features can be the identity information features extracted from the reference image. The identity information can be clothing information, hairstyle information, body shape information of a person contained in the reference image, or any other information that can represent the identity of the person contained in the reference image, which is not limited in the disclosure.

That is, the disclosure can support fusing the target fusion features of the reference image with the image to be processed, so as to realize the fusion processing of the reference image and the image to be processed, which will be described in the following.

In some examples, a pre-trained neural network model can be used to extract the target fusion features from the reference image. The reference image can be used as input parameters of the pre-trained neural network model and the identity information features outputted by the pre-trained neural network model can be obtained. These identity information features are used as the target fusion features.

In some examples, the ArcFace algorithm can be used to process the image to be processed to obtain the identity information features of the image to be processed, and the identity information features can be used as the target fusion features, or any other possible method can also be used to extract the target fusion features from the reference image, which is not limited in the disclosure.

In some examples, extracting the target fusion features from the reference image may include extracting features to be fused from the reference image, and obtaining the target fusion features by encoding the features to be fused. Since the features to be fused are extracted from the reference image and the features to be fused are encoded to obtain the target fusion features, the data amount of the features to be fused can be effectively reduced, and the target fusion features obtained by the encoding can meet the subsequent format requirements of the model on the input data. In addition, the interference caused by irrelevant features can also be filtered out to a certain extent by encoding the features to be fused, thereby improving the quality of the generated target image.

In the reference image, the identity information features that are to be encoded currently can be called the features to be fused, such that the features to be fused are extracted from the reference image and then encoded to obtain the target fused features.

Encoding refers to converting information from a certain format to another format through a specific compression technology, to make the encoded information adaptive to different network bandwidths, different terminal processing capabilities and different user requirements.

In some examples, encoding the features to be fused may be achieved by pre-configuring an encoder in the apparatus for generating an image, and inputting the features to be fused into the pre-configured encoder during the execution of the method, so that the encoder will encode the features to be fused and output the corresponding target fusion features, which is not limited in the disclosure.

At block S103, a plurality of depth feature maps corresponding to the reference image are determined based on the target fusion features.

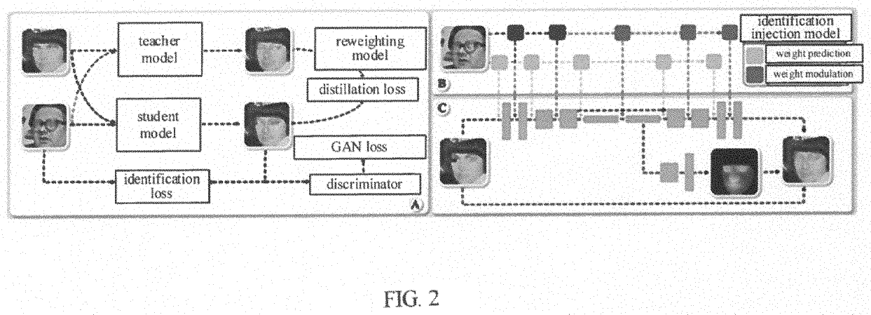

U-shaped neural network (Unet) may be introduced in performing the method for generating an image to generate the target image. FIG. 2 is a schematic diagram illustrating the Unet according to examples of the disclosure.

It is noteworthy that the face image in FIG. 2 is not for a specific user, and cannot reflect the personal information of a specific user. Moreover, the face image is obtained with the authorization of the relevant users, and the acquisition process conforms to the relevant laws and regulations, and does not violate public order and good customs.

In embodiments of the disclosure, the conventional convolution in the Unet can be replaced with the depthwise separable convolution to reduce the amount of parameters of the Unet, for example the amount of parameters of the Unet can be reduced to 0.5 trillion, and the amount of computation is 0.44 Giga Floating Point Operations Per Second (GFLOPS). In this way, during the execution of the method, computing resources can be effectively saved, and the execution efficiency of the method can be effectively improved, so that the method described in the embodiments of the disclosure can be performed by edge devices with poor computing capability (for example, Dimensity mobile phone with 1100 computing capability).

The depthwise separable convolution is an algorithm obtained by improving the standard convolution calculation in the convolutional neural network, which reduces the amount of parameters required for the convolution calculation by splitting the correlation between the spatial dimension and the channel (depth) dimension. Therefore, when the conventional convolution is replaced with the depthwise separable convolution, the execution efficiency of the method can be effectively improved.

The depthwise separable convolution performs the spatial convolution on the channels (depthes), to obtain the feature maps which can be called depth feature maps.

Determining the plurality of depth feature maps corresponding to the reference image may include obtaining the depth feature maps outputted by multiple channels of the depthwise convolutional network by performing the convolution on the reference image separately on the multiple channels of the depthwise convolutional network, or other possible methods of determining the depth feature maps corresponding to the reference image, such as feature parsing method and model parsing method, which is not limited in the disclosure.

At block S104, a target feature map is obtained by fusing the plurality of depth feature maps based on the target fusion features.

After the depth feature maps corresponding to the reference image are determined according to the target fusion features, the depth feature maps can be fused according to the target fusion features into a fused feature map. The fused feature map can be called the target feature map.

In some examples, obtaining the target feature map by fusing the plurality of depth feature maps based on the target fusion features may include performing feature connection processing on the depth feature images by taking the target fusion features for reference, and determining the feature map obtained by the aforementioned processing as the target feature map.

In some examples, the target feature map can be obtained by fusing the depth feature maps according to the target fusion features using a pre-trained feature map fusion model, or using any other possible methods, which is not limited in the disclosure.

That is, in embodiments of the disclosure, the depth feature maps corresponding to the reference image are determined in combination with the target fusion features of the reference image, and the target feature map is obtained by fusing the plurality of depth feature maps, so that the target feature map can represent the identity information carried by the corresponding reference image based on the image depth dimension, and the extraction and representation of the identity information of the reference image are accurate. In addition, the identity information is carried by the target feature map, which can effectively improve the image generation effect during the subsequent process of processing the image to be processed based on the target feature map to generate the target image. Furthermore, the plurality of depth feature maps are obtained by processing the reference image by the depthwise separable convolution, which can effectively reduce the computation amount of the image fusion and the method can be performed by electronic devices with poor computing capability.

At block S105, the target image is generated by processing the image to be processed based on the target feature map.

After the depth feature maps are fused according to the target fusion features into the target feature map, the target image is generated by processing the image to be processed based on the target feature map.

Generating the target image by processing the image to be processed based on the target feature map includes fusing the target feature map and the image to be processed into an image and determining the image as the target image.

In some examples, processing the image to be processed based on the target feature map includes fusing the target feature map with the image to be processed by a pre-trained convolutional neural network into the target image or using any other possible methods, which is not limited in the disclosure.

By obtaining the reference image and the image to be processed, extracting the target fusion features from the reference image, determining depth feature maps corresponding to the reference image based on the target fusion features, fusing the depth feature maps based on the target fusion features into the target feature map, and generating the target image by processing the image to be processed based on the target feature map, the computation amount required for the image fusion can be effectively reduced, such that the method can be performed by electronic devices with poor computing capability and the image generation effect can be effectively improved while saving the computing resources.

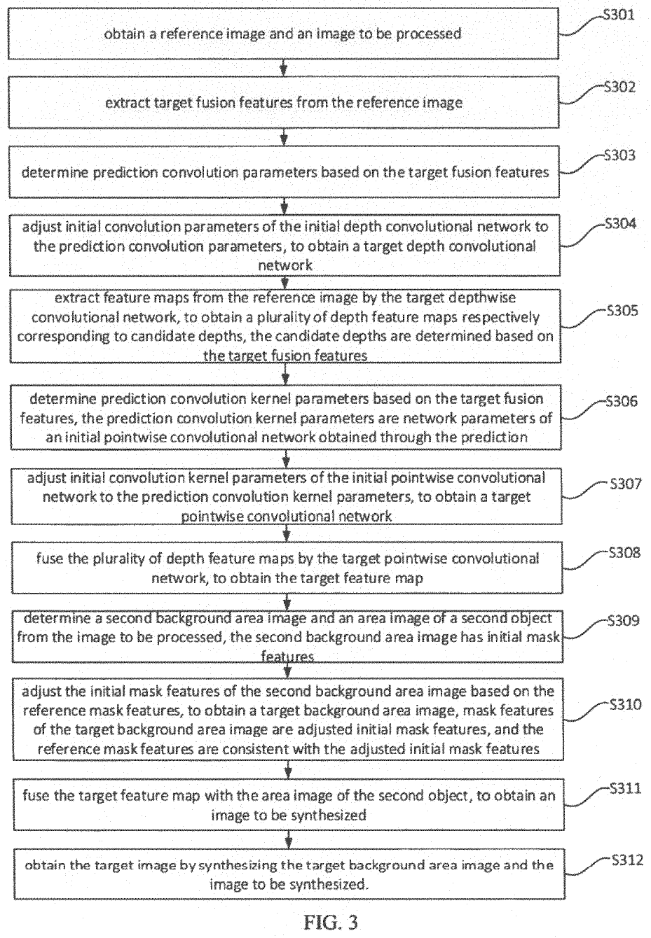

FIG. 3 is a flowchart illustrating a method for generating an image according to examples of the disclosure.

As illustrated in FIG. 3, the method for generating an image includes the following blocks.

At block S301, a reference image and an image to be processed are obtained.

At block S302, target fusion features are extracted from the reference image.

For the description of S301-S302, reference may be made to the foregoing embodiments, and details are not repeated here.

At block S303, prediction convolution parameters are determined based on the target fusion features.

The network parameters of an initial depthwise convolutional network obtained through the prediction can be referred to as the prediction convolution parameters.

In the process of performing the method, the unprocessed depthwise convolutional network can be called the initial depthwise convolutional network. The initial depthwise convolutional network can be the depthwise convolution in the depthwise separable convolutional network, which is not limited in the disclosure.

The network parameters of the Depthwise network (the function of this network is to convolve at each depth to obtain multiple feature maps) may be for example the number of input parameters, the number of filtering layers, the size of convolution kernel, and the number of output channels, which is not limited in the disclosure.

In determining the prediction convolution parameters according to the target fusion features, the number of features to be input to the Depthwise network may be determined according to the number of feature dimensions of the target fusion features. The number of features corresponds to the number of input parameters of the Depthwise network, and the number of the filtering layers is determined according to the various depth values carried by the reference image represented by the target fusion features, or any other number values to which the network parameters of the Depthwise network can be adjusted to can be determined as the prediction network parameters in combination with some feature forms of other possible target fusion features.

In other examples, the target fusion features can be compared with annotated features. The annotated features are pre-calibrated and the appropriate network parameters of the Depthwise network can be pre-configured for the annotated features. The network parameters adaptive to the annotated features matched with the target fusion features are used as the prediction network parameters. The network parameters of the Depthwise network adaptive to the annotated features means that after configuring the Depthwise network based on the adaptive network parameters, the configured Depthwise network can effectively learn the annotated features for modeling, which is not limited in the disclosure.

At block S304, initial convolution parameters of the initial depthwise convolutional network are adjusted to the prediction convolution parameters, to obtain a target depthwise convolutional network.

The network parameters corresponding to the initial depthwise convolutional network are called the initial convolution parameters.

After the prediction convolution parameters are determined according to the target fusion features, the initial convolution parameters of the initial depthwise convolutional network can be adjusted to the prediction convolution parameters, and the adjusted depthwise convolutional network can be used as the target depthwise convolutional network.

For example, adjusting the initial convolution parameters of the initial depthwise convolutional network to the prediction convolution parameters may include replacing the initial convolution parameters of the initial depthwise convolutional network with the prediction convolution parameters or using any other possible methods to obtain the target depthwise convolutional network, which is not limited in the disclosure.

At block S305, feature maps are extracted from the reference image by the target depthwise convolutional network, to obtain a plurality of depth feature maps respectively corresponding to candidate depths. The candidate depths are determined based on the target fusion features.

Various depth values carried by the reference image may be called the candidate depths, and the candidate depths may be determined based on the target fusion features, which is not limited in the disclosure.

It is understandable that generally, the reference image is obtained by taking pictures of an object in the scene, and thus obtaining the reference image is actually imaging spatial stereo information in the scene. Therefore, the reference image may carry multiple depth values accordingly. For example, various depth values carried by the reference image can be determined by analyzing the reference image with the depth analysis algorithm in combination with the internal and external parameters of the photographing device, as the candidate depths, or various depth values carried by the reference image can be determined by measuring the relative distances between the photographing devices and the spatial stereo information in the scene with the time-of-flight algorithm in combination with the focus information of the photographing device, which is not limited in the disclosure.

Since the target depthwise convolutional network can perform the model operation task, i.e., perform the convolution at each depth separately to obtain multiple feature maps, the target depthwise convolutional network can be used to extract feature maps from the reference image, to obtain multiple depth feature maps corresponding to the candidate depths. The candidate depths are determined based on the target fusion features. The target fusion features may be identity information features extracted from the reference image, such as the clothing information, hairstyle information, body shape information of a person contained in the reference image, or any other information that can represent the identity of the person contained in the reference image. When the candidate depths are determined based on the target fusion features, the generated depth feature maps can carry more target fusion features, so that the target fusion features are represented by the depth dimensions, which can effectively improve the representation effect of the target fusion features and ensure the generation quality of subsequent target images.

At block S306, prediction convolution kernel parameters are determined based on the target fusion features. The prediction convolution kernel parameters are network parameters of an initial pointwise convolutional network obtained through the prediction.

The depthwise separable convolution in the Unet mentioned in the disclosure may include a depthwise convolutional network and a pointwise convolutional network. The network parameters corresponding to the pointwise convolutional network may be called the initial convolution kernel parameters.

In some examples, in determining the prediction convolution kernel parameters based on the target fusion features, the number of output channels of a previous layer of the target depthwise convolutional network can be determined based on the target fusion features, and the number of output channels is determined as the prediction convolution kernel parameters (that is, the network parameters of the initial pointwise convolutional network obtained through the prediction), which is not limited in the disclosure.

In other examples, the target fusion features are compared with annotated features. The annotated features can be pre-calibrated and the appropriate network parameters of the Pointwise network can be pre-configured for the annotated features. The network parameters of the Pointwise network adaptive to the annotated features that matches with the target fusion features are determined as the prediction network parameters. The network parameters of the Pointwise network adaptive to the annotation features means that after configuring the Pointwise network based on the adaptive network parameters, the configured Pointwise network can effectively learn the annotated features for modeling, which is not limited in the disclosure.

At block S307, initial convolution kernel parameters of the initial pointwise convolutional network are adjusted to the prediction convolution kernel parameters, to obtain a target pointwise convolutional network.

During the execution of the method for generating an image, the unprocessed Pointwise network can be called the initial pointwise convolutional network, and the initial pointwise convolutional network has corresponding network parameters. These network parameters may be referred to as initial convolution kernel parameters. The initial convolution kernel parameters may be, for example, the number of convolution kernels of the Pointwise network.

After the prediction convolution kernel parameters are determined based on the target fusion features, the initial convolution kernel parameters of the initial pointwise convolutional network are adjusted to the prediction convolution kernel parameters, and the adjusted pointwise convolutional network is determined as the target pointwise convolutional network.

For example, weight modulation method or any other possible method can be used to adjust the initial convolution kernel parameters of the initial pointwise convolutional network to the prediction convolution kernel parameters, to obtain the target pointwise convolutional network, which is not limited in the disclosure.

At block S308, the plurality of depth feature maps are fused by the target pointwise convolutional network into the target feature map.

After the target depthwise convolutional network extracts the feature maps from the reference image to obtain the depth feature maps respectively corresponding to the candidate depths, the target pointwise convolutional network can fuse the depth feature maps into the target feature map. Since the above-mentioned target depthwise convolutional network and the target pointwise convolutional network jointly assist in realizing the learning and modeling function of the Unet and both the target depthwise convolutional network and the target pointwise convolutional network are obtained after adjustment and processing by referring to the target fusion features in the reference image, the learning and modeling function of the Unet can be effectively realized and meanwhile the Unet can effectively learn the target fusion features in the reference image for modeling to obtain the target feature map with better quality. The target feature map can more effectively and accurately express and model the target fusion features in the reference image.

For example, in fusing the depth feature maps by the target pointwise convolutional network into the target feature map, the target pointwise convolutional network can perform weighted combination on the depth feature maps over multiple channels (depths), that is, the prediction convolution kernel parameters and the depth feature maps can be multiplied to obtain the target feature map presenting a standard distribution outputted by the target pointwise convolutional network, or any other possible method can be used to fuse the depth feature maps by the target pointwise convolutional network into the target feature map, which is not limited in the disclosure.

At block S309, a second background area image and an area image of a second object are determined from the image to be processed. The second background area image has initial mask features.

The reference image may include a first background area image and an area image of a first object. The first background area image may be an image contained in the reference image and used to describe the background area.

The first background area image may have corresponding mask features, which may be referred to as the reference mask features.

The image contained in the image to be processed and used to describe the background area may be referred to as the second background area image. Correspondingly, the image contained in the image to be processed and used to describe the second object area may be referred to as the area image of the second object.

For example, when the reference image and the image to be processed are each a face image, the area image of an object may be a face area image, and the background area image may be a hair area image, which is not limited in the disclosure.

The second background area image may have corresponding mask features, which may be referred to as the initial mask features.

Determining the second background area image and the area image of the second object from the image to be processed may include dividing the image to be processed by an apparatus for processing an image, to obtain the second background area image and the area image of the second object, or using any other possible methods to determine the second background area image and the area image of the second object from the image to be processed, which is not limited in the disclosure.

At block S310, the initial mask features of the second background area image are adjusted based on the reference mask features, to obtain a target background area image. Mask features of the target background area image are initial mask features that have been adjusted, and the reference mask features and the initial mask features that have been adjusted satisfy consistency conditions.

The initial mask features of the second background area image may be adjusted according to the reference mask features of the first background area image until the reference mask features and the initial mask features that have been adjusted (also called adjusted initial mask features) satisfy the consistency conditions/The image corresponding to the adjusted initial mask features is determined as the target background area image.

The consistency conditions may be, for example, keeping the reference mask features consistent with the adjusted initial mask features, or the consistency conditions may be adaptively configured according to the business requirements in the actual image generation scene, which is not limited in the disclosure.

At block S311, the target feature map are fused with the area image of the second object, to obtain an image to be synthesized.

Fusion processing may be performed on the target feature map and the area image of the second object of the image to be processed, and the image obtained by the aforementioned fusion processing is the image to be synthesized.

In some embodiments, the target feature map can be fused with the area image of the second object by a pre-trained convolutional neural network, to realize the fusion processing of the target feature map and the area image of the second object of the image to be processed, to obtain the image to be synthesized. Alternatively, the target feature map can also be fused with the area image of the second object in any other possible method to obtain the image to be synthesized, such as, image fusion algorithm, modulation-based image fusion method, which is not limited in the disclosure.

In some examples, fusing the target feature map and the area image of the second object to obtain the image to be synthesized includes: fusing the target feature map and the area image of the second object into an image to be fused; inputting the area image of the first object into a pre-trained mask prediction model to obtain prediction mask features of the first object outputted by the pre-trained mask prediction model; and fusing the prediction mask features with the image to be fused to obtain the image to be synthesized. Since the prediction mask features of the area image of the first object are determined by the pre-trained mask prediction model, the flexibility and operability of the extraction of the prediction mask features can be effectively improved, the accuracy of the prediction mask features can be effectively improved, and the prediction mask features can accurately represent the image information of the area image of the first object, so that the generated image can fully represent the identity information of the reference image, thereby effectively improving the image generation effect.

After the area image of the second object of the image to be processed is determined, fusion processing may be performed on the target feature map and the area image of the second object, and the image obtained after the fusion processing is the image to be fused.

A mask prediction model trained in advance can be called pre-trained mask prediction model. The pre-trained mask prediction model can be an AI model, such as, a neural network model or a machine learning model. Certainly, any other possible AI models capable of performing mask prediction can also be used, which is not limited in the disclosure.

The area image of the first object of the reference image may be used as the input parameters of the pre-trained mask prediction model, to obtain the mask features outputted by the pre-trained mask prediction model, and these mask features are called the prediction mask features of the first object.

After obtaining the prediction mask features of the first object outputted by the pre-trained mask prediction model, the prediction mask features and the image to be fused are fused to obtain a fused image, i.e., the image to be synthesized.

At block S312, the target image is obtained by synthesizing the target background area image and the image to be synthesized.

After the target background area image and the image to be synthesized are obtained, the target background area image and the image to be synthesized can be synthesized (the synthesizing method may be, for example, image splicing, which is not limited), and the image obtained after the synthesis processing is determined as the target image.

Since the second background area image and the area image of the second object are determined from the image to be processed, the initial mask features of the second background area image are adjusted according to the reference mask features, to obtain the target background area image, the target feature map is fused with the area image of the second object to obtain the image to be synthesized, and the target image is obtained by synthesizing the target background area image and the image to be synthesized. In this way, the technical problem that there is a difficulty in the background transferring due to complex image background can be effectively solved, and image jitter problems such as sudden change of the image background and flickering of the image objects that occur during the execution of the method can also be effectively solved, thereby improving the image generation effect.

In embodiments of the disclosure, in order to improve the stability of the method for generating an image, a distillation-based training scheme can be introduced. As illustrated in FIG. 2, by supervising the image generation model through the output results of a trained image generation model, the image generation effect can be further improved. In this process, the teacher model will produce some failure cases during image generation, such as low identity similarity between the reference image and the image to be processed or poor quality of the generated image, and using these failure cases to distill the student model will cause the student model to generate failure cases as well. In order to solve the above problems, the disclosure can design a quality evaluation module for output results of the teacher model. By using the identity similarity between the outputs of the teacher model and the outputs of the reference image and using the quality of the target image outputted by the teacher model for evaluation, and then by using the evaluation results to dynamically adjust the weight of the distillation loss, the image generation effect of the student model can be effectively improved.

With the method according to embodiments of the disclosure, the reference image and the image to be processed are obtained. The target fusion features are extracted from the reference image. The plurality of depth feature maps corresponding to the reference image are determined based on the target fusion features. The target feature map is obtained by fusing the plurality of depth feature maps based on the target fusion features. The target image is generated by processing the image to be processed based on the target feature map. In this way, the amount of computation required for the image fusion can be effectively reduced, and the method can be performed by electronic devices with poor computing capability, so that the image generation effect can be effectively improved while saving the computing resources. Since the target depthwise convolutional network can perform the model operation task, i.e., perform the convolution at each depth to obtain the feature maps, the target depth convolutional network can be used to extract the feature maps from the reference image to obtain the depth feature maps respectively corresponding to candidate depths. The candidate depths are determined based on the target fusion features, and the target fusion features can be the identity information features extracted from the reference image. The identity information can be, for example, the clothing information, hairstyle information, body shape information of a person contained in the reference image, or any other information that can represent the identity of the person contained in the reference image, so that when the candidate depths are determined based on the target fusion features, the generated depth feature maps can carry more target fusion features, to realize the representation of the target fusion features by the depth dimensions, which can effectively improve the representation effect of target fusion features and ensure the quality of the target image obtained in the subsequent generation process. Since the above-mentioned target depth convolutional network and the target pointwise convolutional network jointly assist in realizing the learning and modeling function of the Unet, and both the target depthwise convolutional network and the target pointwise convolutional network are obtained after adjustment and processing by referring to the target fusion features in the reference image, the learning and modeling function of the Unet can be effectively realized and meanwhile the Unet can effectively learn the target fusion features in the reference image for modeling to obtain the target feature map with better quality. The target feature map can more effectively and accurately express and model the target fusion features in the reference image. Since the second background area image and the area image of the second object are determined from the image to be processed, the initial mask features of the second background area image are adjusted according to the reference mask features to obtain the target background area image, the target feature map is fused with the area image of the second object to obtain the image to be synthesized, and the target image is obtained by synthesizing the target background area image and the image to be synthesized. In this way, the technical problem that there is a difficulty in the background transferring due to complex image background can be effectively solved, and image jitter problems such as sudden change of the image background and flickering of the image objects that occur during the execution of the method can also be effectively solved, thereby improving the image generation effect.

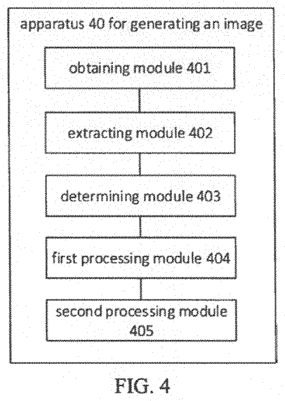

FIG. 4 is a block diagram illustrating an apparatus for generating an image according to examples of the disclosure.

As illustrated in FIG. 4, an apparatus 40 for generating an image includes: an obtaining module 401, an extracting module 402, a determining module 403, a first processing module 404 and a second processing module 405.

The obtaining module 401 is configured to obtain a reference image and an image to be processed.

The extracting module 402 is configured to extract target fusion features from the reference image.

The determining module 403 is configured to determine a plurality of depth feature maps corresponding to the reference image based on the target fusion features.

The first processing module 404 is configured to obtain a target feature map by fusing the plurality of depth feature maps based on the target fusion features.

The second processing module 405 is configured to generate a target image by processing the image to be processed based on the target feature map.

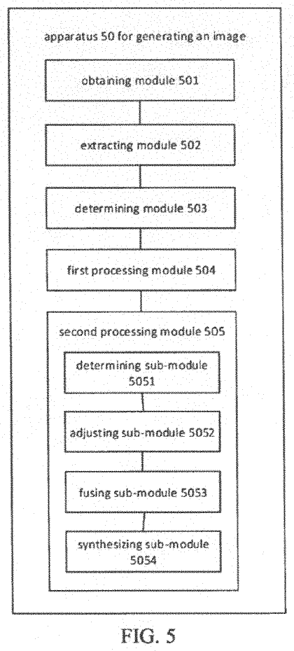

FIG. 5 is a block diagram illustrating an apparatus for generating an image according to examples of the disclosure. As illustrated in FIG. 5, the apparatus 50 for generating an image includes: an obtaining module 501, an extracting module 502, a determining module 503, a first processing module 504 and a second processing module 505.

The extracting module 502 is further configured to extract features to be fused from the reference image; and obtain the target fusion features by encoding the features to be fused.

In some examples, the determining module 503 is further configured to determine prediction convolution parameters based on the target fusion features, in which the prediction convolution parameters are network parameters of an initial depthwise convolutional network obtained by prediction; adjust initial convolution parameters of the initial depthwise convolutional network to the prediction convolution parameters, to obtain a target depthwise convolutional network; and extract feature maps from the reference image by the target depthwise convolutional network, to obtain a plurality of depth feature maps respectively corresponding to candidate depths, in which the candidate depths are determined based on the target fusion features.

In some examples, the first processing module 504 is further configured to determine prediction convolution kernel parameters based on the target fusion features, in which the prediction convolution kernel parameters are network parameters of an initial pointwise convolutional network obtained by prediction; adjust initial convolution kernel parameters of the initial pointwise convolutional network to the prediction convolution kernel parameters, to obtain a target pointwise convolutional network; and fuse the plurality of depth feature maps by the target pointwise convolutional network, to obtain the target feature map.

In some examples, the reference image includes a first background area image and an area image of a first object, the target fusion features are configured to describe image features of the first object, and the first background area image has reference mask features.

The second processing module 505 includes: a determining sub-module 5051, an adjusting sub-module 5052, a fusing sub-module 5053 and a synthesizing sub-module 5054.

The determining sub-module 5051 is configured to determine a second background area image and an area image of a second object from the image to be processed, in which the second background area image has initial mask features.

The adjusting sub-module 5052 is configured to adjust the initial mask features of the second background area image based on the reference mask features, to obtain a target background area image, in which mask features of the target background area image are initial mask features that have been adjusted, and the reference mask features and the initial mask features that have been adjusted satisfy consistency conditions.

The fusing sub-module 5053 is configured to fuse the target feature map with the area image of the second object, to obtain an image to be synthesized.

The synthesizing sub-module 5054 is configured to obtain the target image by synthesizing the target background area image and the image to be synthesized.

In some embodiments, the fusing sub-module 5053 is further configured to fuse the target feature map with the area image of the second object, to obtain an image to be fused; input the area image of the first object into a pre-trained mask prediction model, to obtain prediction mask features of the first object output by the pre-trained mask prediction model; and fuse the prediction mask features with the image to be fused, to obtain the image to be synthesized.

In some examples, the obtaining module 501 is further configured to obtain a source image and an initial image, in which the source image comprises: a source area image of a first object, and the initial image includes: an initial area image of a second object; perform points alignment processing on the source area image contained in the source image and a standard object image based on a first number of key points, to obtain the reference image; and perform alignment processing on the initial area image contained in the initial image and the standard object image based on a second number of key points, to obtain the image to be processed, in which a value of the first number is greater than a value of the second number.

It is understandable that the apparatus 50 in FIG. 5 and the apparatus 40 in FIG. 4, the obtaining module 501 and the obtaining module 401, the extracting module 502 and the extracting module 402, the determining module 503 and the determining module 403, the first processing module 504 and the first processing module 404, the second processing module 505 and the second processing module 405, may have the same function and structure.

It is noteworthy that the foregoing explanations on the method for generating an image are also applicable to the apparatus for generating an image of this embodiment.

In embodiments of the disclosure, the reference image and the image to be processed are obtained. The target fusion features are extracted from the reference image. The plurality of depth feature maps corresponding to the reference image are determined based on the target fusion features. The target feature map is obtained by fusing the plurality of depth feature maps based on the target fusion features. The target image is generated by processing the image to be processed based on the target feature map. In this way, the amount of computation required for the image fusion can be effectively reduced, and the method can be performed by electronic devices with poor computing capability, so that the image generation effect can be effectively improved while saving the computing resources.

According to the embodiments of the disclosure, the disclosure provides an electronic device, and a readable storage medium and a computer program product.

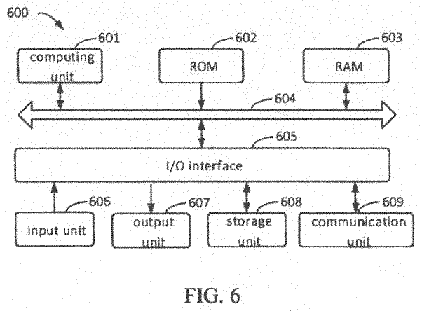

FIG. 6 is a block diagram of an example electronic device 600 used to implement the method for generating an image according to the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 6, the electronic device 600 includes: a computing unit 601 performing various appropriate actions and processes based on computer programs stored in a read-only memory (ROM) 602 or computer programs loaded from the storage unit 608 to a random access memory (RAM) 603. In the RAM 603, various programs and data required for the operation of the device 600 are stored. The computing unit 601, the ROM 602, and the RAM 603 are connected to each other through a bus 604. An input/output (I/O) interface 605 is also connected to the bus 604.

Components in the device 600 are connected to the I/O interface 605, including: an inputting unit 606, such as a keyboard, a mouse; an outputting unit 607, such as various types of displays, speakers; a storage unit 608, such as a disk, an optical disk; and a communication unit 609, such as network cards, modems, and wireless communication transceivers. The communication unit 609 allows the device 600 to exchange information/data with other devices through a computer network such as the Internet and/or various telecommunication networks.

The computing unit 601 may be various general-purpose and/or dedicated processing components with processing and computing capabilities. Some examples of computing unit 601 include, but are not limited to, a CPU, a graphics processing unit (GPU), various dedicated AI computing chips, various computing units that run machine learning model algorithms, and a digital signal processor (DSP), and any appropriate processor, controller and microcontroller. The computing unit 601 executes the various methods and processes described above, such as the method for generating an image. For example, in some embodiments, the above method may be implemented as a computer software program, which is tangibly contained in a machine-readable medium, such as the storage unit 608. In some embodiments, part or all of the computer program may be loaded and/or installed on the device 600 via the ROM 602 and/or the communication unit 609. When the computer program is loaded on the RAM 603 and executed by the computing unit 601, one or more steps of the method described above may be executed. Alternatively, in other embodiments, the computing unit 601 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve defects such as difficult management and weak business scalability in the traditional physical host and Virtual Private Server (VPS) service. The server may also be a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for generating an image, comprising:
obtaining a reference image and an image to be processed;
extracting target fusion features from the reference image;
determining a plurality of depth feature maps corresponding to the reference image based on the target fusion features;
obtaining a target feature map by fusing the plurality of depth feature maps based on the target fusion features; and
generating a target image by processing the image to be processed based on the target feature map.

2. The method of claim 1, wherein extracting the target fusion features from the reference image comprises:
extracting features to be fused from the reference image; and
obtaining the target fusion features by encoding the features to be fused.

3. The method of claim 1, wherein determining the plurality of depth feature maps corresponding to the reference image based on the target fusion features comprises:
determining prediction convolution parameters based on the target fusion features, wherein the prediction convolution parameters are network parameters of an initial depthwise convolutional network obtained by prediction;
adjusting initial convolution parameters of the initial depthwise convolutional network to the prediction convolution parameters, to obtain a target depthwise convolutional network; and
extracting feature maps from the reference image by the target depthwise convolutional network, to obtain a plurality of depth feature maps respectively corresponding to candidate depths, wherein the candidate depths are determined based on the target fusion features.

4. The method of claim 3, wherein obtaining the target feature map by fusing the plurality of depth feature maps based on the target fusion features comprises:
determining prediction convolution kernel parameters based on the target fusion features, wherein the prediction convolution kernel parameters are network parameters of an initial pointwise convolutional network obtained by prediction;
adjusting initial convolution kernel parameters of the initial pointwise convolutional network to the prediction convolution kernel parameters, to obtain a target pointwise convolutional network; and
fusing the plurality of depth feature maps by the target pointwise convolutional network, to obtain the target feature map.

5. The method of claim 1, wherein the reference image comprises: a first background area image and an area image of a first object, the target fusion features are configured to describe image features of the first object, and the first background area image has reference mask features; and
wherein generating the target image by processing the image to be processed based on the target feature map comprises:
determining a second background area image and an area image of a second object from the image to be processed, wherein the second background area image has initial mask features;
adjusting the initial mask features of the second background area image based on the reference mask features, to obtain a target background area image, wherein mask features of the target background area image are initial mask features that have been adjusted, and the reference mask features and the initial mask features that have been adjusted satisfy consistency conditions;
fusing the target feature map with the area image of the second object, to obtain an image to be synthesized; and
obtaining the target image by synthesizing the target background area image and the image to be synthesized.

6. The method of claim 5, wherein fusing the target feature map with the area image of the second object, to obtain the image to be synthesized comprises:
fusing the target feature map with the area image of the second object, to obtain an image to be fused;
inputting the area image of the first object into a pre-trained mask prediction model, to obtain prediction mask features of the first object output by the pre-trained mask prediction model; and
fusing the prediction mask features with the image to be fused, to obtain the image to be synthesized.

7. The method of claim 1, wherein obtaining the reference image and the image to be processed comprises:
obtaining a source image and an initial image, wherein the source image comprises: a source area image of a first object, and the initial image comprises: an initial area image of a second object;
performing point alignment processing on the source area image contained in the source image and a standard object image based on a first number of key points, to obtain the reference image; and
performing alignment processing on the initial area image contained in the initial mage and the standard object image based on a second number of key points, to obtain the image to be processed, wherein a value of the first number is greater than a value of the second number.

8. An electronic device, comprising:
at least one processor; and
a memory communicatively coupled to the at least one processor; wherein,
the memory stores instructions executable by the at least one processor, when the instructions are executed by the at least one processor, the at least one processor is configured to:
obtain a reference image and an image to be processed;
extract target fusion features from the reference image;
determine a plurality of depth feature maps corresponding to the reference image based on the target fusion features;
obtain a target feature map by fusing the plurality of depth feature maps based on the target fusion features; and
generating a target image by processing the image to be processed based on the target feature map.

9. The electronic device of claim 8, wherein the at least one processor is configured to:
extract features to be fused from the reference image; and
obtain the target fusion features by encoding the features to be fused.

10. The electronic device of claim 8, wherein the at least one processor is configured to:
determine prediction convolution parameters based on the target fusion features, wherein the prediction convolution parameters are network parameters of an initial depthwise convolutional network obtained by prediction;
adjust initial convolution parameters of the initial depthwise convolutional network to the prediction convolution parameters, to obtain a target depthwise convolutional network; and
extract feature maps from the reference image by the target depthwise convolutional network, to obtain a plurality of depth feature maps respectively corresponding to candidate depths, wherein the candidate depths are determined based on the target fusion features.

11. The electronic device of claim 10, wherein the at least one processor is configured to:
determine prediction convolution kernel parameters based on the target fusion features, wherein the prediction convolution kernel parameters are network parameters of an initial pointwise convolutional network obtained by prediction;
adjust initial convolution kernel parameters of the initial pointwise convolutional network to the prediction convolution kernel parameters, to obtain a target pointwise convolutional network; and
fuse the plurality of depth feature maps by the target pointwise convolutional network, to obtain the target feature map.

12. The electronic device of claim 8, wherein the reference image comprises: a first background area image and an area image of a first object, the target fusion features are configured to describe image features of the first object, and the first background area image has reference mask features; and
wherein the at least one processor is configured to:
determine a second background area image and an area image of a second object from the image to be processed, wherein the second background area image has initial mask features;
adjust the initial mask features of the second background area image based on the reference mask features, to obtain a target background area image, wherein mask features of the target background area image are initial mask features that have been adjusted, and the reference mask features and the initial mask features that have been adjusted satisfy consistency conditions;
fuse the target feature map with the area image of the second object, to obtain an image to be synthesized; and
obtain the target image by synthesizing the target background area image and the image to be synthesized.

13. The electronic device of claim 12, wherein the at least one processor is configured to:
fuse the target feature map with the area image of the second object, to obtain an image to be fused;
input the area image of the first object into a pre-trained mask prediction model, to obtain prediction mask features of the first object output by the pre-trained mask prediction model; and
fuse the prediction mask features with the image to be fused, to obtain the image to be synthesized.

14. The electronic device of claim 7, wherein the at least one processor is configured to:
obtain a source image and an initial image, wherein the source image comprises: a source area image of a first object, and the initial image comprises: an initial area image of a second object;
perform point alignment processing on the source area image contained in the source image and a standard object image based on a first number of key points, to obtain the reference image; and
perform alignment processing on the initial area image contained in the initial image and the standard object image based on a second number of key points, to obtain the image to be processed, wherein a value of the first number is greater than a value of the second number.

15. A non-transitory computer-readable storage medium having computer instructions stored thereon, wherein the computer instructions are configured to cause a computer to perform a method for generating an image, the image comprising:
obtaining a reference image and an image to be processed;
extracting target fusion features from the reference image;
determining a plurality of depth feature maps corresponding to the reference image based on the target fusion features;
obtaining a target feature map by fusing the plurality of depth feature maps based on the target fusion features; and
generating a target image by processing the image to be processed based on the target feature map.

16. The non-transitory computer-readable storage medium of claim 15, wherein extracting the target fusion features from the reference image comprises:
extracting features to be fused from the reference image; and
obtaining the target fusion features by encoding the features to be fused.

17. The non-transitory computer-readable storage medium of claim 15, wherein determining the plurality of depth feature maps corresponding to the reference image based on the target fusion features comprises:
determining prediction convolution parameters based on the target fusion features, wherein the prediction convolution parameters are network parameters of an initial depthwise convolutional network obtained by prediction;
adjusting initial convolution parameters of the initial depthwise convolutional network to the prediction convolution parameters, to obtain a target depthwise convolutional network; and
extracting feature maps from the reference image by the target depthwise convolutional network, to obtain a plurality of depth feature maps respectively corresponding to candidate depths, wherein the candidate depths are determined based on the target fusion features.

18. The non-transitory computer-readable storage medium of claim 17, wherein obtaining the target feature map by fusing the plurality of depth feature maps based on the target fusion features comprises:
determining prediction convolution kernel parameters based on the target fusion features, wherein the prediction convolution kernel parameters are network parameters of an initial pointwise convolutional network obtained by prediction;
adjusting initial convolution kernel parameters of the initial pointwise convolutional network to the prediction convolution kernel parameters, to obtain a target pointwise convolutional network; and
fusing the plurality of depth feature maps by the target pointwise convolutional network, to obtain the target feature map.

19. The non-transitory computer-readable storage medium of claim 15, wherein the reference image comprises: a first background area image and an area image of a first object, the target fusion features are configured to describe image features of the first object, and the first background area image has reference mask features; and
wherein generating the target image by processing the image to be processed based on the target feature map comprises:
determining a second background area image and an area image of a second object from the image to be processed, wherein the second background area image has initial mask features;
adjusting the initial mask features of the second background area image based on the reference mask features, to obtain a target background area image, wherein mask features of the target background area image are initial mask features that have been adjusted, and the reference mask features and the initial mask features that have been adjusted satisfy consistency conditions;
fusing the target feature map with the area image of the second object, to obtain an image to be synthesized; and
obtaining the target image by synthesizing the target background area image and the image to be synthesized.

20. The non-transitory computer-readable storage medium of claim 19, wherein fusing the target feature map with the area image of the second object, to obtain the image to be synthesized comprises:
fusing the target feature map with the area image of the second object, to obtain an image to be fused;
inputting the area image of the first object into a pre-trained mask prediction model, to obtain prediction mask features of the first object output by the pre-trained mask prediction model; and
fusing the prediction mask features with the image to be fused, to obtain the image to be synthesized.
